(19) United States
(12) Patent Application Publication
(10) Pub. No.: US 2014/0123935 A1
(43) Pub. Date: May 8, 2014

(54) FUEL INJECTION CONTROL DEVICE AND FUEL INJECTION CONTROL METHOD

(71) Applicants: Yoshihiro Imaoka, Kawasaki-shi (JP); Takao Inoue, Yokohama-shi (JP); Takuma Suzuki, Kawasaki-shi (JP)

(72) Inventors: Yoshihiro Imaoka, Kawasaki-shi (JP); Takao Inoue, Yokohama-shi (JP); Takuma Suzuki, Kawasaki-shi (JP)

(73) Assignee: NISSAN MOTOR CO., LTD., Yokohama-shi, Kanagawa (JP)

(21) Appl. No.: 14/129,146

(22) PCT Filed: Jun. 4, 2012
(86) PCT No.: PCT/JP2012/064386

§ 371 Date: Dec. 24, 2013

(30) Foreign Application Priority Data
Jul. 28, 2011 (JP) 2011-165595

(51) Int. Cl. F02D 41/30

(52) U.S. Cl. CPC F02D 41/30
USPC 123/295

(57) ABSTRACT

A fuel injection control device of an in-cylinder direct injection spark ignition-type internal combustion engine 1 in which fuel injection is carried out once or multiple times from an intake stroke to a compression stroke during homogeneous combustion, wherein a fuel injection timing at which a charging efficiency is improved in accordance with a pressure oscillation is calculated based on a frequency determined based on an in-cylinder volume of pressure oscillation generated in the cylinder in accordance with fuel injection, and one of the fuel injection(s) is carried out at the fuel injection timing.

### TECHNICAL FIELD

The present invention relates to a fuel injection control device of an internal combustion engine.

### BACKGROUND ART

Multi-stage injection in which the required fuel injection amount is divided into a plurality of injections is known as a means of fuel injection control in a spark ignition-type internal combustion engine in which fuel is directly injected into a cylinder. For example, JP 2008-31932A discloses that in multi-stage injection, injection is prohibited during a period in which the piston speed is high. Thereby, disruptions in the tumble flow are prevented and homogeneity of the air-fuel mixture in the cylinder can be improved using the in-cylinder flow.

### SUMMARY OF INVENTION

In the case of an in-cylinder direct injection spark ignition-type internal combustion engine, pressure oscillation in the cylinder is generated due to fuel injection, and the charging efficiency fluctuates periodically in accordance with such pressure oscillation.

However, it is not mentioned a fuel injection timing and the relations of the pressure vibration in JP2008-31932A. Therefore, in the fuel injection control device of JP 2008-31932A, the fuel may be injected at a timing at which the charging efficiency is relatively low.

Therefore, an object of the present invention is to provide a fuel injection control device that can improve the charging efficiency in an in-cylinder direct injection spark ignition-type internal combustion engine that performs multi-stage injection.

In order to achieve the above-mentioned object, the present invention provides a fuel injection control device of an in-cylinder direct injection spark ignition-type internal combustion engine in which fuel injection is carried out once or multiple times from an intake stroke to a compression stroke during homogeneous combustion, characterized in that a fuel injection timing at which a charging efficiency is improved by pressure oscillation is calculated based on a frequency determined based on an in-cylinder volume of pressure oscillation generated in the cylinder in accordance with fuel injection, and one of the fuel injection(s) is carried out at the fuel injection timing.

A detailed explanation of the invention as well as other features and advantages will be explained in the following descriptions in the specification and illustrated in the attached drawings.

### BRIEF DESCRIPTION OF DRAWINGS

FIG. 1 is a configuration view of an in-cylinder direct injection spark ignition-type internal combustion engine according to a first embodiment of the present invention.

FIG. 2 is a graph illustrating the relationship between charging efficiency and fuel injection timing.

FIG. 3 is a graph illustrating the relationship between in-cylinder average pressure and fuel injection timing.

FIG. 4 is a graph illustrating the relationship between intake air flow rate at a cylinder inlet and fuel injection timing.

FIG. 5 is a graph illustrating the relationship between charging efficiency and fuel injection timing.

FIG. 6 is a flow chart illustrating a fuel injection control routine of the first embodiment that is executed by a controller.

FIG. 7 is a map in which the number of injections is set based on a engine speed and a load.

FIG. 8 is a diagram illustrating the fuel injection timing in each load region.

FIG. 9 is a flow chart illustrating a fuel injection control routine of a second embodiment that is executed by a controller.

FIG. 10 is a map illustrating the fuel injection timing in a first stage of a 3-stage or 2-stage injection.

FIG. 11 is a map illustrating the fuel injection timing in a second stage of a 3-stage or 2-stage injection.

FIG. 12 is a map illustrating the fuel injection timing in a third stage of a 3-stage injection.

### DESCRIPTION OF EMBODIMENTS

### First Embodiment

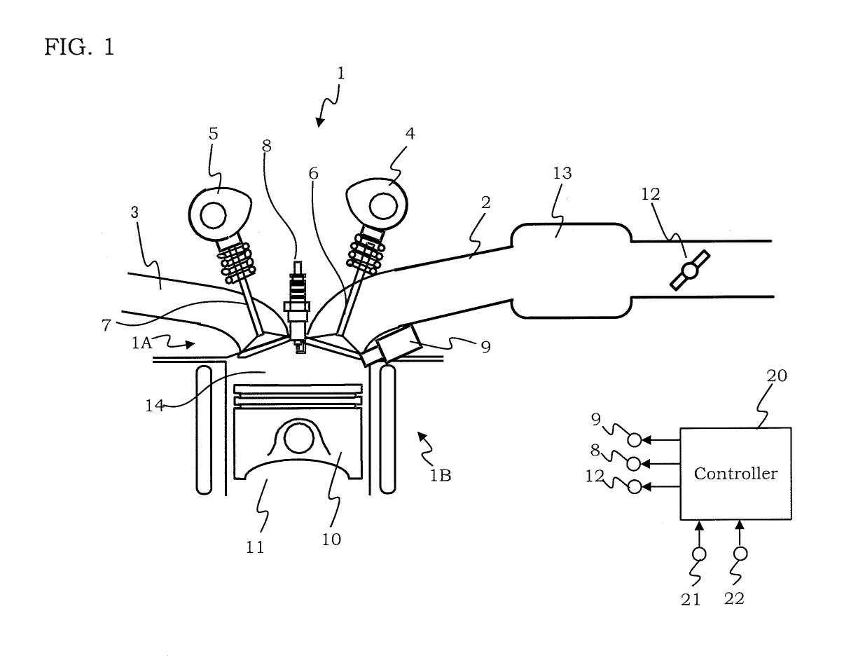

FIG. 1 is a configuration view illustrating one air cylinder of an in-cylinder direct injection spark ignition-type internal combustion engine (hereinafter referred to simply as “internal combustion engine 1”) 1 according to a first embodiment of the present invention.

The internal combustion engine 1 is configured to include a cylinder head 1A and a cylinder block 1B. A piston 10 is accommodated such that it can move reciprocally in a cylinder 11 provided to the cylinder block 1B. A combustion chamber 14 is defined by a wall surface of the cylinder 11, a crestal plane of the piston 10, and a lower surface of the cylinder head 1A.

An intake passage 2 and an exhaust passage 3 are formed in the cylinder head 1A. The intake passage 2 and the exhaust passage 3 both open into the combustion chamber 14, and the openings thereof are respectively opened and closed by an intake valve 6 and an exhaust valve 7. The intake valve 6 and the exhaust valve 7 are respectively driven by an intake cam shaft 4 and an exhaust cam shaft 5. The intake cam shaft 4 includes a variable valve mechanism that can modify the valve timing.

A spark plug 8 and a fuel injection valve 9 are disposed on the cylinder head 1A so as to face the combustion chamber 14.

A collector tank 13 is interposed in the intake passage 2, and a throttle valve 12 is disposed on the intake flow upstream side of the collector tank 13.

A controller 20 executes control of the opening degree of the throttle valve 12, injection timing of the fuel injection valve 9, control of the fuel injection such as the injection amount, and control of the ignition timing of the spark plug 8.

The controller 20 executes the above-mentioned controls based on detection signals of an accelerator opening degree sensor 21, a crank angle sensor 22, and the like. The controller 20 is constituted by a microcomputer including a central processing unit (CPU), a read-only memory (ROM), a random access memory (RAM), and an input-output interface (I/O interface). The controller 20 can be constituted by a plurality of microcomputers.

In the internal combustion engine 1 configured as described above, the controller 20 sets a target fuel injection amount in accordance with the operating conditions such as the engine speed and the required load, and further sets a number of injections for injecting the target fuel injection amount and a timing for each injection.

In the case of homogeneous combustion, for the purpose of improving the homogeneity of the air-fuel mixture in the cylinder, it has been known to carry out multi-stage injection in which the target fuel injection amount per one cycle is divided into a plurality of injections. In the case of single-stage injection, in order to increase the homogeneity, it is preferable to extend the time in which the fuel atomizes and mixes with air, or in other words to inject the fuel at a crank angle near the intake top dead center. However, if the fuel is injected at a crank angle near the intake top dead center, the time until spark ignition increases, and this leads to a decrease in the cooling effect by the endothermic reaction that occurs when the fuel vaporizes. In other words, in the case of single-stage injection, there is a trade-off between the homogeneity improving effect and the cooling effect. With regard to this point, in multi-stage injection, it is possible to balance the homogeneity improvement and the cooling effect by setting two of the timings among the plurality of fuel injection timings to a timing near the intake top dead center and a timing near the ignition timing.

The fuel injection timing also correlates with the charging efficiency. For example, in the case of 3-stage injection, if two among the three fuel injections are set to the timings described above in order to achieve a balance between the homogeneity improvement and the cooling effect, the charging efficiency changes depending on the remaining fuel injection timing. The relationship between the charging efficiency and the fuel injection timing will now be explained below.

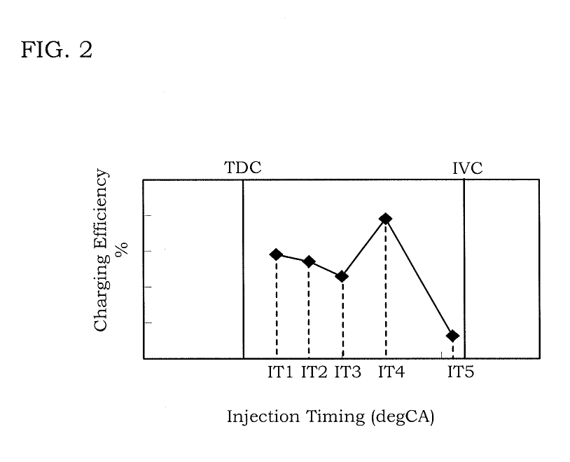

FIG. 2 is a graph illustrating the relationship between the charging efficiency and the fuel injection timing. The vertical axis is the charging efficiency (%), and the horizontal axis is the fuel injection timing (deg. CA). TDC represents the intake top dead center and IVC represents the intake valve closing timing.

Upon measuring the charging efficiency of five patterns of fuel injecting timing (IT1 to IT5), as shown in FIG. 2, it was found that the charging efficiency gradually decreases from IT1 to IT3 and then rises in IT4. The charging efficiency decreases again in IT5, which is near the intake valve closing time.

This kind of increase/decrease period of the charging efficiency is believed to be caused by pressure oscillation generated by the fuel injection.

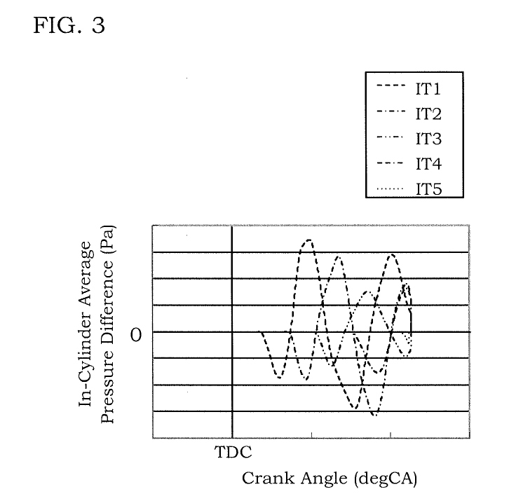

FIG. 3 is a graph illustrating the relationship between in-cylinder average pressure and the fuel injection timing. The vertical axis represents the difference in the in-cylinder average pressure (Pa) between a case in which fuel is injected and a case in which fuel is not injected, and the horizontal axis represents the crank angle (deg. CA). TDC represents the intake top dead center. IT1 to IT5 respectively indicate cases in which fuel is injected at the fuel injection timings of IT1 to IT5 of FIG. 2.

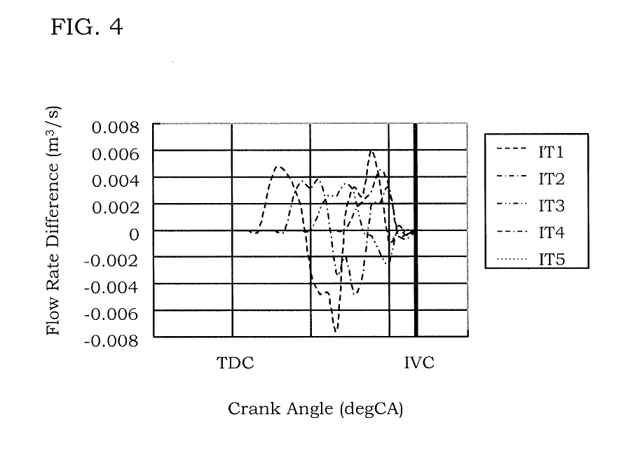

FIG. 4 is a graph illustrating the relationship between intake air flow rate at the cylinder inlet and the fuel injection timing. The vertical axis represents the difference in the intake air flow rate (m³/s) at the cylinder inlet between a case in which fuel is injected and a case in which fuel is not injected, and the horizontal axis represents the crank angle (deg. CA). TDC represents the intake top dead center. IT1 to IT5 respectively indicate cases in which fuel is injected at the fuel injection timings of IT1 to IT5 of FIG. 2.

As shown in FIG. 3, the in-cylinder average pressure is lower in the case of fuel injection than in the case in which fuel is not injected, regardless of at which fuel injection timing the fuel is injected. This is believed to be because the inside of the cylinder is cooled by latent heat of vaporization of the injected fuel.

Further, as shown in FIG. 4, the intake air flow rate at the cylinder inlet increases in accordance with a decrease in the in-cylinder average pressure. Thereafter, repetition of an increase in the in-cylinder pressure in accordance with an increase in the intake air flow rate and a decrease in the intake air flow rate in accordance with an increase in the in-cylinder pressure can be seen. Pressure oscillations in the cylinder occur due to this kind of fuel injection, and the intake air flow rate at the cylinder inlet also oscillates. In the case of IT5, the duration of time until the intake valve closing timing is short, and thus there is almost no oscillation of the in-cylinder pressure and the intake air flow rate.

Comparing FIG. 3 and FIG. 2, in the case of IT3 which is the fuel injection timing at which the charging efficiency decreases, the increase/decrease period of the intake air flow rate at the cylinder inlet matches the crank angle from the start of fuel injection to the intake valve closing timing.

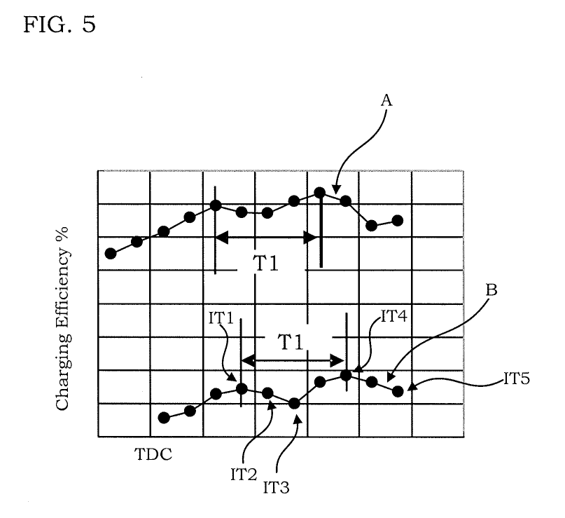

FIG. 5 is a graph illustrating the relationship between the charging efficiency and the fuel injection timing similar to FIG. 2, and it illustrates the results measured for more fuel injection timings than those in FIG. 2. In FIG. 5, the solid lines A and B respectively represent cases in which the valve timing is different, or in other words cases in which the intake valve closing timing is different. IT1 to IT5 of solid line B correspond to IT1 to IT5 of FIG. 2.

As shown in FIG. 5, the increase and decrease of the charging efficiency exhibits periodicity, and IT3 is at a valley on the increase/decrease curve. The positions of the peaks and valleys on the increase/decrease curve of the charging efficiency deviate if the intake valve closing timing changes, but the period from one peak to the next peak (T1 in FIG. 5) does not change.

Thus, if fuel is injected at a timing which does not fall in a valley of the increase/decrease period of the charging efficiency and at which the intake air flow rate at the cylinder inlet is high, the charging efficiency can be improved.

When the intake air flow rate at the cylinder inlet is high, then the flow speed of intake air flowing into the cylinder is also high, and thus the in-cylinder flow can also be strengthened. However, if the object is to strengthen the in-cylinder flow, then the peak of oscillation of the intake air flow rate is preferably closer to the intake valve closing timing. If it is close to the intake valve closing timing, then the duration of time until the ignition timing becomes short, and thus ignition can be carried out in a state in which the in-cylinder flow is maintained.

In the case that an intake air flow device such as a tumble control valve or a swirl control valve is provided, the timing at which the charging efficiency is improved will change depending on the state of the intake air flow device as well. Therefore, the timing at which the charging efficiency is improved must be measured for each state of the intake air flow device.

Next, the fuel injection control will be explained.

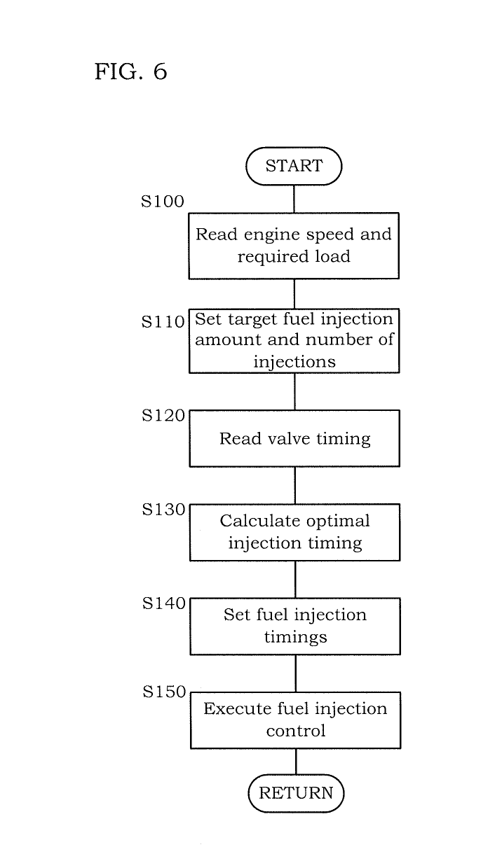

FIG. 6 is a flow chart illustrating a fuel injection control routine that is executed by the controller 20. This control routine is repeatedly executed in short cycles of, for example, approximately 10 milliseconds. The control routine will be explained below in accordance with the steps thereof.

In step S100, the controller 20 reads the engine speed and the required load. The engine speed to be read is calculated based on a detected value of the crank angle sensor 22. The required load to be read is calculated based on a detected value of the accelerator opening degree sensor 21. These can both be calculated by a publicly-known method.

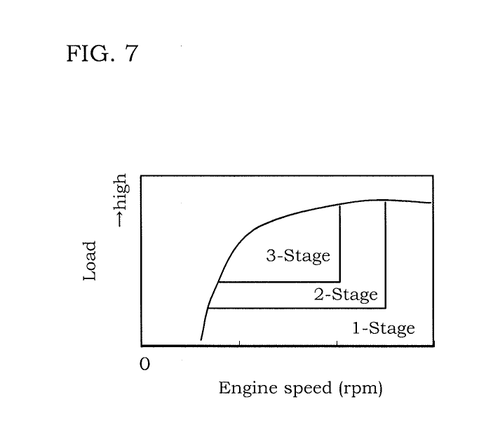

In step S110, the controller 20 sets the target fuel injection amount and the number of injections. The target fuel injection amount is set by a map search or the like based on the engine speed and the load similar to publicly-known fuel injection control. The number of injections is set by, for example, creating in advance a map in which the number of injections is set based on the engine speed and the load as shown in FIG. 7, and then searching on the map.

In step S120, the controller 20 reads the valve timing. Specifically, the controller 20 reads the intake valve closing timing. The controller 20 also controls the variable valve mechanism, and thus it can read the current valve timing.

In step S130, the controller 20 calculates the optimal injection timing. First, the period T_CA from peak to peak of the charging efficiency described above is calculated by formula (1).

$$T\_CA = B \times Ne \times \frac{\sqrt{l \times V}}{d} \qquad ( 1 )$$

B is a constant, I is the port length from the outlet of the collector tank 13 to the inlet of the cylinder, d is the average diameter of the above-mentioned port, and V is the in-cylinder volume at the time of fuel injection.

The above formula results from converting a frequency calculated by formula (2), which is for calculating the resonance frequency of a Helmholtz resonator, to a period (deg. CA).

$$f = \frac{C}{2 π} \times \sqrt{\frac{S}{1 \times V}} \qquad ( 2 )$$

C is the acoustic velocity, and S is the cross-section area of the above-mentioned port.

Next, a fuel injection timing IT_ηc which corresponds to a peak of the oscillation period of the charging efficiency is calculated by formula (3) using the period T_CA.

IT_η_{c}=IVC−α×T_{—}CA−A×Ne (3)

α=0.5, 1.5, 2.5, . . . , and A is a constant.

In step S140, the controller 20 sets the timing for each fuel injection in accordance with the number of injections set in step S110. The setting of the fuel injection timings will be explained below for each load region. The injection amount of each fuel injection is, for example, one third of the target injection amount in the case of 3-stage injection. In the case of 2-stage injection, the injection amount of each fuel injection is set such that the ratio of the first injection amount to the second injection amount is 7:3.

(Low/Middle Load Region)

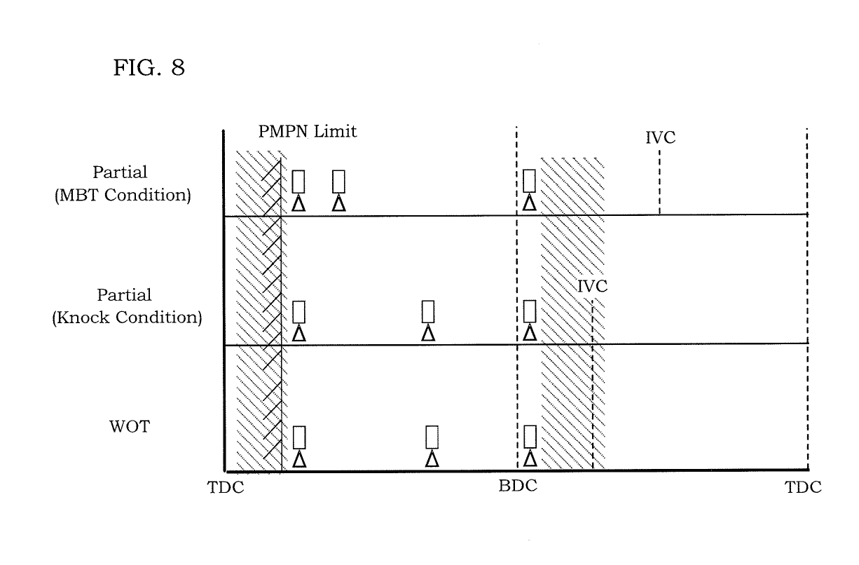

In the low/middle load region, in which the ignition timing can be set to the optimal ignition timing (MBT), the fuel injection timings are set as shown in FIG. 8(A). The first fuel injection timing is set as close to the advance angle side as possible, e.g. 40 to 90 (degATDC), in order to improve the homogeneity.

In order to improve the homogeneity in the cylinder, the fuel injection timing is preferably as close to the advance angle side as possible. However, a knock determination window is set near the top dead center, and if the fuel is injected within this window, the determination may be erroneous due to sounds or vibrations that accompany the operation of the fuel injection valve 9. Further, there are also restrictions such as combustion and smoke limits. Thus, the above-described fuel injection timing is set as close to the advance angle side as possible under the above-mentioned restrictions.

The second fuel injection timing is set to be spaced apart by a minimum injection interval from the first fuel injection. A minimum injection interval is established by the mechanical restrictions of the fuel injection valve 9, such as the time from when the previous fuel injection has finished to when the next fuel injection can be started, the time from when an applied voltage reaches a peak to the start of injection, the minimum injection pulse width, and the like. In the low/middle load region, the intake air amount is relatively low and the atomized fuel and air do not easily mix. Therefore, mixing can be promoted and the homogeneity can be improved by setting the second fuel injection timing as close to the advance angle side as possible.

The third fuel injection timing is set to a fuel injection timing determined by formula (3) so as to strengthen the in-cylinder flow. However, since a knock determination window is set near the bottom dead center as well, it is necessary to avoid this window.

In the case of 2-stage injection, one of the first and third injection timings described above is selected. This is because in a region in which there is no possibility that knocking will occur, the combustion efficiency and degree of constant volume as well as the fuel economy are improved by the improvement in homogeneity and the strengthening of the in-cylinder flow.

(High Load Region)

In a high load region in which there is a possibility that knocking will occur, the fuel injection timings are set as shown in FIG. 8(B). The first fuel injection timing is set in the same manner as in the low-middle load region.

The second fuel injection timing is set to a fuel injection timing determined by formula (3) so as to increase the intake air flow rate.

The third fuel injection timing is set to a fuel injection timing that is as close to the intake valve closing timing as possible in a range in which the fuel injection completion timing does not fall within the knock determination window near the bottom dead center, e.g. 140 to 240 degATDC. By setting the fuel injection timing near the intake valve closing timing, the cooling effect by latent heat of vaporization of the fuel increases and this is effective in preventing knocking. The specific fuel injection timing is calculated in advance by experimentation or the like.

In the case of injection in 2 or fewer stages, the fuel injection timings are set in a priority order of a fuel injection timing for improving the homogeneity, a fuel injection timing for improving the cooling effect, and a fuel injection timing for improving the fluidity. This is because in a region in which there is a possibility that knocking will occur, it is necessary to suppress knocking in addition to improving the consumption efficiency and the degree of constant volume.

(Full Load Operation)

In the full load operation, the fuel injection timings are set as shown in FIG. 8(C). The first fuel injection timing is set in the same manner as in the low/middle load region.

The second fuel injection timing is set to a fuel injection timing determined by formula (3) so as to improve the charging efficiency.

The third fuel injection timing is set to a fuel injection timing for the cooling effect in the same manner as in the high load region.

In the case of injection in 2 or fewer stages, the fuel injection timings are set in a priority order of a fuel injection timing for improving the charging efficiency, a fuel injection timing for improving the cooling effect, and a fuel injection timing for improving the homogeneity. This is because in the full load operation, improving the charging efficiency in order to generate a larger torque is given the highest priority.

The explanation will now return to the flowchart.

Once the fuel injection timings are set in step S140, the fuel injections are executed in step S150.

In an internal combustion engine, the necessary effect changes in each operating region, but according to the above-described control routine, a fuel injection timing at which the necessary effect is obtained in each operating region can be set.

According to the present embodiment described above, a fuel injection timing at which the charging efficiency is improved is calculated based on the frequency of in-cylinder pressure oscillation, and one injection among the multi-stage injections is carried out at this fuel injection timing. Thereby, the charging efficiency can be improved or the in-cylinder flow can be strengthened. Further, since this fuel injection timing is calculated based on the intake passage diameter, the distance from the collector tank to the combustion chamber inlet, the combustion chamber volume, the intake valve closing timing, and the engine speed, an appropriate fuel injection timing can be set with a simple calculation.

If the valve timing is changed, the fuel injection timing at which the charging efficiency increases or the in-cylinder flow is strengthened also changes. However, since such fuel injection timings are calculated in accordance with the operating state, an appropriate fuel injection timing can also be set during a transition in which the operating state changes.

The effect which should be prioritized changes depending on the operating state. However, since the combination of a fuel injection timing for improving the homogeneity, a fuel injection timing for improving the cooling effect, and a fuel injection timing for improving the charging efficiency or the like is switched in accordance with the operating state, an appropriate effect can be obtained.

In the low/middle load region, at least one of the fuel injection timing for improving the homogeneity and the fuel injection timing for strengthening the in-cylinder flow is set. If fuel is injected at both of these fuel injection timings, a balance between the homogeneity improvement and the in-cylinder flow strengthening can be achieved. At least one of these can be improved even if the number of injections is small.

In the high load region, the fuel injection timings are set in a priority order of a fuel injection timing for improving the homogeneity, a fuel injection timing for improving the cooling effect, and a fuel injection timing for strengthening the in-cylinder flow. Thereby, not only is the homogeneity increased, but knocking can also be reliably suppressed in a region in which there is a possibility that knocking will occur.

In the full load operation, the fuel injection timings are set in a priority order of a fuel injection timing for improving the charging efficiency or strengthening the in-cylinder flow, a fuel injection timing for improving the cooling effect, and a fuel injection timing for improving the homogeneity. Thereby, in a region in which a higher output is required, the output can be improved by improving the charging efficiency or strengthening the in-cylinder flow.

### Second Embodiment

In the second embodiment, the constitution of the internal combustion engine 1 to which the embodiment is applied is the same as in the first embodiment. However, the second embodiment differs from the first embodiment in that the fuel injection timings of the multi-stage injection are mapped in advance and this map is searched to set the timings. Thus, the routine for setting the fuel injection timings will be explained below.

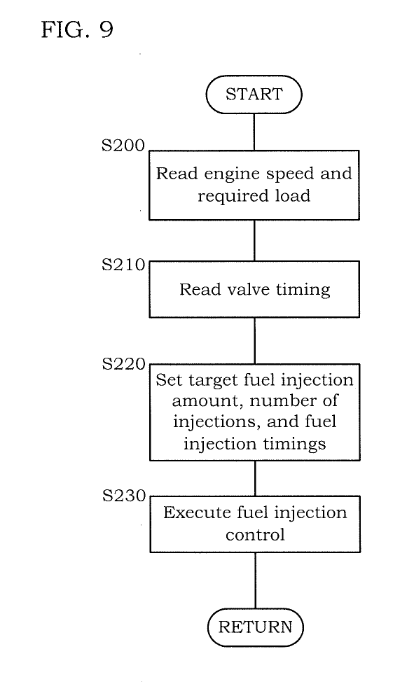

FIG. 9 is a flow chart illustrating a fuel injection control routine that is executed by the controller 20 in the second embodiment. This control routine is repeatedly executed in short cycles of, for example, approximately 10 milliseconds. The control routine will be explained below in accordance with the steps thereof.

Steps S200 and S210 are respectively identical to steps S100 and S120 in FIG. 6, and thus explanations thereof will be omitted.

In step S220, the controller 20 sets the target fuel injection amount and the number of fuel injections, and further sets each fuel injection timing. The setting of the target fuel injection amount and the number of fuel injections is the same as in step S110 in FIG. 6 and thus an explanation thereof will be omitted.

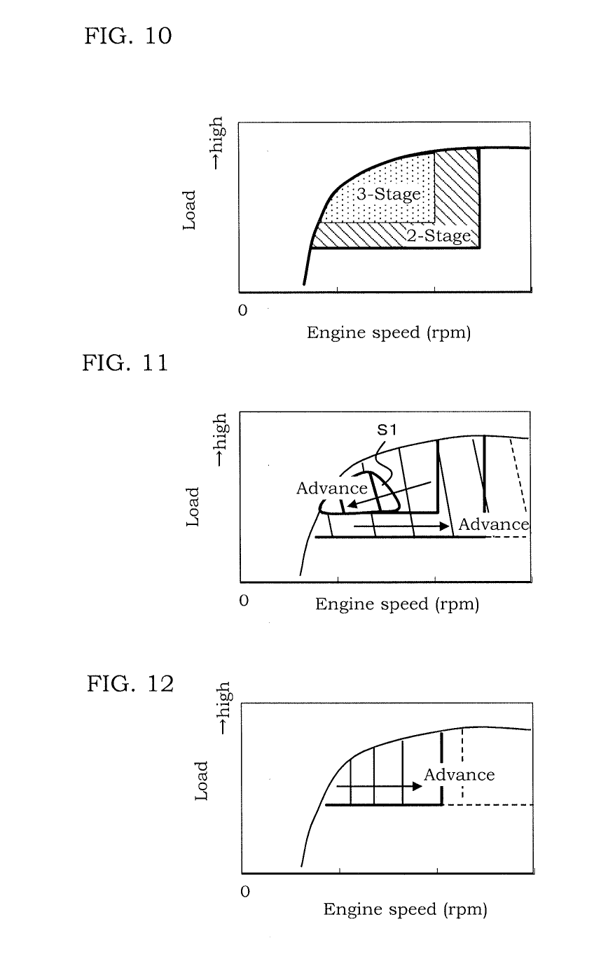

The setting of each fuel injection timing is carried out using a map that is prepared in advance. FIGS. 10, 11, and 12 are maps for setting the first, second, and third fuel injection timings. In each of these drawings, the vertical axis is the load and the horizontal axis is the engine speed.

In the map of FIG. 10, a fuel injection timing for improving the homogeneity is assigned as the first fuel injection in the map for setting the number of fuel injections shown in FIG. 7. If the first fuel injection timing is to be set within the range explained in the first embodiment, e.g. 60 degATDC, then the first fuel injection timing is set to 60 degATDC in both 3-stage and 2-stage injection.

The map of FIG. 11 illustrates a fuel injection timing for improving the charging efficiency or strengthening the in-cylinder flow as the second fuel injection. In the case of 3-stage injection, the fuel injection timing deviates toward the advance angle side as the number of rotations decreases. Meanwhile, in the case of 2-stage injection, the fuel injection timing deviates toward the advance angle side as the number of rotations increases. In the case of 3-stage injection, in a region in which the atomized fuel and air do not easily mix on the low load side (S1 in FIG. 11), the second fuel injection timing is set to be spaced apart by a minimum injection interval from the first fuel injection explained above.

The map of FIG. 12 illustrates a fuel injection timing for improving the cooling effect as the third fuel injection. This fuel injection timing deviates toward the advance angle side as the number of rotations increases.

Once the fuel injection timings are set in step S220, the fuel injections are executed in step S230.

By using the maps explained above, fuel injection timings which are suitable for the operating state can be set with a low calculation load compared to the first embodiment.

Embodiments of the present invention have been explained above, but these embodiments merely indicate a portion of the application examples of the present invention, and the technical scope of the present invention is not limited to the specific constitutions of the above-described embodiments.

This application claims priority based on Japanese Patent Application No. 2011-165595 filed with the Japan Patent Office on Jul. 28, 2011, the entire contents of which are incorporated into this specification.

1. A fuel injection control device of an in-cylinder direct injection spark ignition-type internal combustion engine in which fuel injection is carried out once or multiple times from an intake stroke to a compression stroke during homogeneous combustion,
wherein a fuel injection timing at which a charging efficiency is improved in accordance with a pressure oscillation is calculated based on a frequency determined based on an in-cylinder volume of pressure oscillation generated in the cylinder in accordance with fuel injection, and one of the fuel injection(s) is carried out at the fuel injection timing.

2. The fuel injection control device according to claim 1, wherein the fuel injection timing at which the charging efficiency is improved is calculated based on an intake passage diameter, a distance from a collector tank to a combustion chamber inlet, a combustion chamber volume, an intake valve closing timing, and an engine speed.

3. The fuel injection control device according to claim 2, comprising a map which is prepared in advance upon calculating the fuel injection timing at which the charging efficiency is improved, wherein the fuel injecting timing is set by searching the map in accordance with an operating state.

4. The fuel injection control device according to claim 2, wherein the fuel injection timing is set by calculating the fuel injection timing at which the charging efficiency is improved in accordance with an operating state.

5. The fuel injection control device according to claim 1, wherein a combination of a fuel injection timing for improving homogeneity of an air-fuel mixture in the cylinder, a fuel injection timing for improving a cooling effect by latent heat of vaporization of the fuel, and the fuel injection timing at which the charging efficiency is improved is switched in accordance with an operating state.

6. The fuel injection control device according to claim 5, wherein at least one of the fuel injection timing for improving the homogeneity and the fuel injection timing at which the charging efficiency is improved is set when the in-cylinder direct injection spark ignition-type internal combustion engine is in operation at low/middle load region.

7. The fuel injection control device according to claim 5, wherein the fuel injection timing(s) is set in a priority order of the fuel injection timing for improving the homogeneity, the fuel injection timing for improving the cooling effect by latent heat of vaporization of the fuel, and the fuel injection timing at which the charging efficiency is improved when the in-cylinder direct injection spark ignition-type internal combustion engine is in operation at high load region.

8. The fuel injection control device according to claim 5, wherein the fuel injection timing(s) is set in a priority order of the fuel injection timing at which the charging efficiency is improved, the fuel injection timing for improving the cooling effect by latent heat of vaporization of the fuel, and the fuel injection timing for improving the homogeneity when the in-cylinder direct injection spark ignition-type internal combustion engine is in operation at full load.

9. A fuel injection control method of an in-cylinder direct injection spark ignition-type internal combustion engine in which fuel injection is carried out once or multiple times from an intake stroke to a compression stroke during homogeneous combustion, the method comprising:
calculating a fuel injection timing at which a charging efficiency is improved in accordance with a pressure oscillation based on a frequency determined based on an in-cylinder volume of pressure oscillation generated in the cylinder in accordance with fuel injection,
carrying out one of the fuel injection(s) at the fuel injection timing.
